(19) United States
(12) Patent Application Publication
(10) Pub. No.: US 2019/0096399 A1
(43) Pub. Date: Mar. 28, 2019

(54) CALL VOICE PROCESSING SYSTEM AND CALL VOICE PROCESSING METHOD

(71) Applicant: Hitachi Information & Telecommunication Engineering, Ltd., Kanagawa (JP)

(72) Inventor: Takaaki SASAKI, Nakai-machi (JP)

(21) Appl. No.: 16/018,112

(22) Filed: Jun. 26, 2018

(30) Foreign Application Priority Data
Sep. 27, 2017 (JP) 2017-185610

(51) Int. Cl. G10L 15/22; G06F 17/28

(52) U.S. Cl. CPC G10L 15/22; G10L 2015/225; G06F 17/2854

(57) ABSTRACT

When an incoming call is received, a voice recognition control device automatically decides a first language (Japanese) as a language corresponding to call information. A voice recognizing device recognizes voice information during a call when an incoming call is received using a first voice recognition engine corresponding to the first language. After the incoming call is received, the voice recognition control device switches the first language to a second language (English) in response to a switching instruction to instruct switching from the first language to the second language, and recognizes the voice information during a call after the incoming call is received using a second voice recognition engine corresponding to the second language.

### CROSS-REFERENCE TO RELATED APPLICATION

The present application claims priority from Japanese application JP 2017-185610, filed on Sep. 27, 2017, the content of which is hereby incorporated by reference into this application.

### TECHNICAL FIELD

The present invention relates to a call voice processing system and a call voice processing method.

### BACKGROUND ART

In call centers or offices, call content between customers of a call destination and an operator is recorded to prepare for future troubles or review the content. Since recording data is converted into text data through voice recognition, the recording data can be searched through a computer system and displayed or printed to effectively use as business data.

For the voice recognition performed at the call center, voice recognition using different voice recognition engines (dictionaries) prepared for different languages is performed in a technique disclosed in JP 2017-78753 (Patent Document 1).

### SUMMARY OF THE INVENTION

In the technique disclosed in Patent Document 1, voices are recognized by employing different voice recognition engine for different languages. However, in the technique disclosed in Patent Document 1, recorded voices are recognized using the voice recognition engine after a call ends. The voice recognition engine is not switched during a call with a customer, and the same voice recognition engine is used during a call.

As described above, in the technique disclosed in Patent Document 1, an improvement in a recognition rate of voice recognition by employing an optimal voice recognition engine corresponding to a language used during a call with a customer is not taken into consideration.

It is an object of the present invention to improve the recognition rate of voice recognition by adopting the optimum voice recognition engine corresponding to the language used during the call with the customer.

A call voice processing system of one embodiment of the present invention includes a voice recognizing device including a plurality of voice recognition engine for performing voice recognition of a plurality of languages, a call recording information managing device including a language correspondence table in which a plurality of pieces of call information are associated with a plurality of languages and a switching table used for performing switching to one of the plurality of languages, and a voice recognition control device including a voice recognition engine selection table in which the plurality of languages are associated with the plurality of voice recognition engines, in which, when an incoming call is received, the voice recognition control device automatically decides a first language as a language corresponding to the call information with reference to the language correspondence table, the voice recognizing device recognizes the voice information during the call when the incoming call is received using a first voice recognition engine corresponding to the first language with reference to the voice recognition engine selection table, after the incoming call is received, the voice recognition control device switches the first language to a second language different from the first language with reference to the switching table in response to a switching instruction to instruct switching from the first language to the second language, and the voice recognizing device recognizes the voice information during the call after the incoming call is received using a second voice recognition engine corresponding to the second language with reference to the voice recognition engine selection table.

A call voice processing method of one embodiment of the present invention includes preparing a first voice recognition engine for performing voice recognition of a first language and a second voice recognition engine for performing voice recognition of a second language different from the first language, automatically deciding the first language as a language corresponding to call information when an incoming call is received, recognizing voice information during a call when the incoming call is received using the first voice recognition engine corresponding to the first language, determining whether or not the second voice recognition engine corresponding to the second language is in use in response to a switching instruction to instruct switching from the first language to the second language after the incoming call is received, switching the first language to the second language in a case in which it is determined that the second voice recognition engine is not in use and the second voice recognition engine is available and recognizing the voice information during the call after the incoming call is received using the second voice recognition engine corresponding to the second language, and recognizing the voice information after the incoming call is received after the call ends using the second voice recognition engine corresponding to the second language in a case in which it is determined that the second voice recognition engine is in use and the second voice recognition engine is unavailable.

According to one aspect of the present invention, it is possible to improve the recognition rate of the voice recognition by employing the optimal voice recognition engine corresponding to the language used during the call with the customer.

### BRIEF DESCRIPTION OF THE DRAWINGS

FIG. 1 is an overall configuration diagram of a call center system.

FIG. 2 is a view illustrating an operator PC screen of an operator terminal.

FIG. 3 is a diagram illustrating an incoming call number language correspondence table (T-4).

FIG. 4 is a diagram illustrating a manual switching table (T-5).

FIG. 5 is a diagram illustrating a call information table (T-6).

FIG. 6 is a diagram illustrating a voice recognition engine selection table (T-7).

FIG. 7 is a diagram illustrating a voice recognition result table (T-8).

FIG. 8 is a flowchart for describing an operation when an incoming call is received.

FIG. 9 is a flowchart for describing an operation when a voice recognition engine is switched by an operator manipulation.

FIG. 10 is a system configuration diagram for describing an operation when an incoming call is received.

FIG. 11 is a system configuration diagram for describing an operation when a voice recognition engine is switched by an operator manipulation.

FIG. 12 is a system configuration diagram for describing a re-execution operation at the time of failure.

FIG. 13A is a diagram illustrating a call information table before rewriting when an incoming call is received.

FIG. 13B is a diagram illustrating a call information table after rewriting when an incoming call is received.

FIG. 14A is a diagram illustrating a call information table before rewriting when manual switching is performed.

FIG. 14B is a diagram illustrating a call information table after rewriting when manual switching is performed.

FIG. 15A is a diagram illustrating a voice recognition engine selection table before rewriting.

FIG. 15B is a diagram illustrating a voice recognition engine selection table after rewriting.

FIG. 16A is a diagram illustrating a manual switching table before rewriting when manual switching is performed.

FIG. 16B is a diagram illustrating a manual switching table after rewriting when manual switching is performed.

### EMBODIMENT

A call voice processing system is a system that recognizes call content of customers in telephone correspondence businesses of call centers or the like and operators in real time and manages and saves recognition results.

In real-time call voice processing systems in call centers, in general, voice recognition is performed by associating computer telephony integration (CTI) information such as an incoming call number with a voice recognition engine (dictionary). The CTI information is information specifying a language. In a case in which a plurality of languages are dealt with, a voice recognition engine is prepared for each language. Here, CTI is a generic term for technology in which a telephone and a computer are used in cooperation. In the call center or the like, it is a technique of inquiring customer information from a telephone number of a customer to a database or of making automatic call origination and automatic forwarding.

When an operator deals with calls corresponding to a plurality of languages, in a case in which a language of a customer does not coincide with a language linked with the CTI information, an appropriate voice recognition engine is not selected, and the recognition accuracy is likely to decrease.

In a call voice processing system of a related art, since the voice recognition engine is selected in accordance with a link between the CTI information such as the incoming call number and the voice recognition engine, a voice recognition engine suitable for conversation content is unable to be selected, leading to the low recognition accuracy.

Further, as a method of dealing with a plurality of languages without depending on the CTI information, a method of causing a plurality of voice recognition engines usable in a system to operate in parallel may be used, but it requires a lot of system resources and a high cost.

In an embodiment, a function of enabling the operator to select the voice recognition engine through a manual manipulation is provided in addition to the automatic selection of the voice recognition engine based on the CTI information. Accordingly, it is possible to select an appropriate voice recognition engine while suppressing the use of system resources.

In an embodiment, a real time system capable of supporting a plurality of languages is implemented with less system resources as compared with the method of causing a plurality of voice recognition engine to operate in parallel. Specifically, an optimal voice recognition engine is used in accordance with the manual manipulation of the operator without depending solely on the CTI information, and thus the recognition rate is increased. Further, since a plurality of voice recognition engine does not operate at the same time, the system resources are effectively used.

In an embodiment, an optimum recognition engine can be employed for each different language during the call with the customer, and the voice recognition rate during the call is improved. Hereinafter, an exemplary embodiment will be described with reference to the appended drawings.

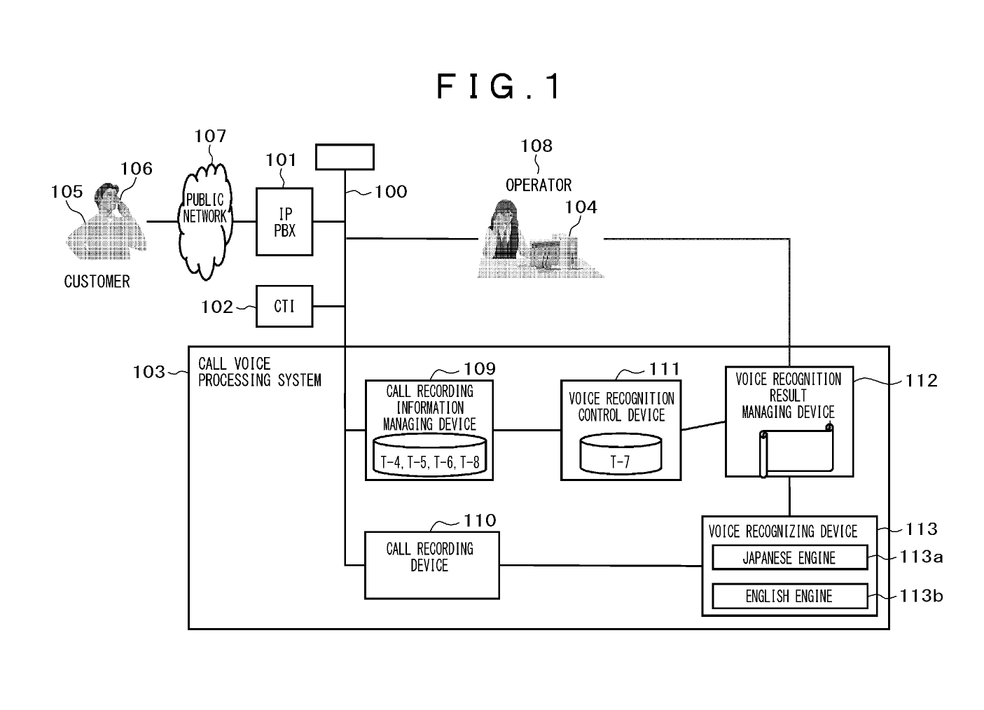

First, a call center system will be described with reference to FIG. 1. As illustrated in FIG. 1, the call center system is configured such that an Internet protocol-private branch exchange (IP-PBX) device 101, a CTI device 102, a call voice processing system 103, and an operator terminal 104 are connected via a network 100.

Upon receiving a call from a call terminal 106 of a customer 105, the IP-PBX device 101 performs protocol conversion of an IP network and a public network 107, call control of incoming and outgoing calls, and the like.

The CTI device 102 acquires call information (an incoming call number or the like) from the IP-PBX device 101 and transmits the call information to the voice call processing system 103.

The operator terminal 104 is an operator PC terminal used for operator business by an operator 108, and performs a call with the call terminal 106 of the customer 105 via the public network 107.

The IP-PBX device 101 connected from the call terminal 106 of the customer 105 via the public network 107 establishes a connection with the operator terminal 104 via the network 100 and performs a call. The operator 108 can perform a telephone manipulation through the operator terminal 104, and if an incoming call from the customer 105 is displayed on the operator terminal 104, the operator 108 manipulates a response through the operator terminal 104, so that the customer 105 and the operator 108 enter a call state.

The call voice processing system 103 includes a call recording information managing device 109, a call recording device 110, a voice recognition control device 111, a voice recognition result managing device 112, and a voice recognizing device 113.

The call recording device 110 is a device for recording data streams of a call exchanged by the call terminal 106 as recording data via the IP-PBX device 101. The call in the call terminal 106 is transferred to the call recording device 110 and stored as a recording file. The call recording device 110 acquires and records a mirrored call voice and transmits the mirrored call voice to the voice recognizing device 113. The call recording information managing device 109 is a server for managing the call information and the recording information in association with each other.

The voice recognizing device 113 converts the recording data into text data through the voice recognition engine. The voice recognizing device 113 includes a Japanese engine 113a and an English engine 113b. Commonly, the Japanese engine 113a is used in a case in which the customer 105 speaks in Japanese during the call, and the English engine 113b is used in a case in which the customer 105 speaks in English during the call. The Japanese engine 113a and the English engine 113b perform a voice recognition algorithm process and output the recognition result as the text data. The voice recognizing device 113 can have a plurality of voice recognition engines for respective languages.

The voice recognition control device 111 receives a voice recognition request from the operator terminal 104 and gives an instruction to the voice recognizing device 113. The voice recognition result managing device 112 stores the text data output from the voice recognizing device 113 in a database and accumulates the voice recognition results. A result recognized by browser access or a language selection screen is displayed on the operator terminal 104.

Next, the call voice processing system of the embodiment will be described.

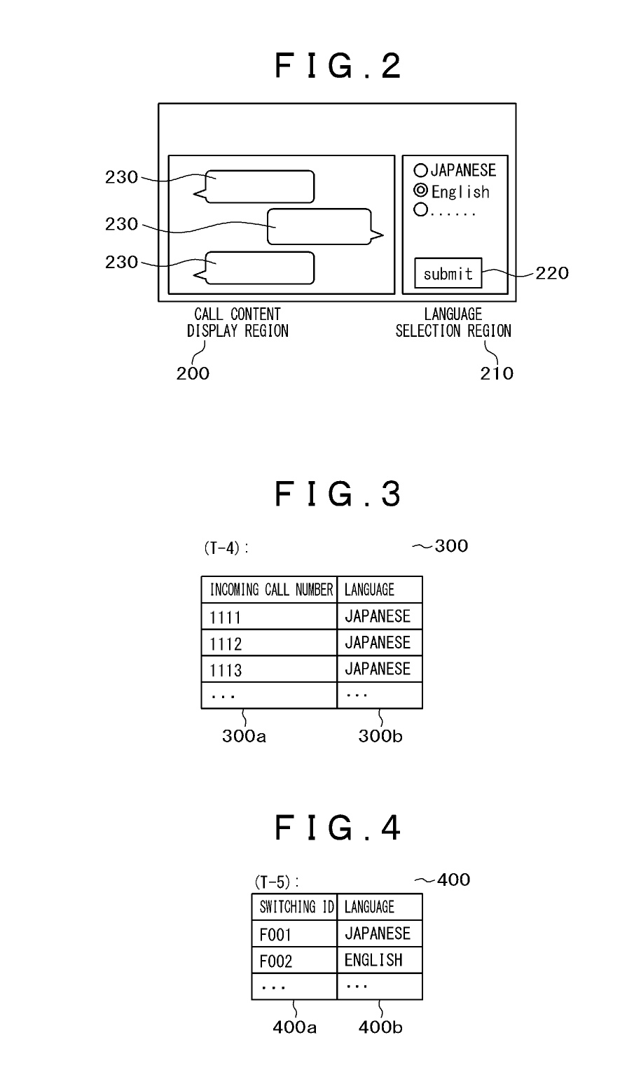

As illustrating in FIG. 2, an operator PC screen of the operator terminal 104 includes a call content display region 200 and a language selection region 210 adjacent to the call content display region 200. The recognition result obtained by recognizing the voice using the voice recognition engine of the voice recognizing device 113 is displayed in the call content display region 200 of the operator terminal 104 through the voice recognition result managing device 112. A language selection screen is displayed in the language selection region 210.

The operator PC screen of the operator terminal 104 displays the call content display region 200 in which the voice recognition result is displayed and the language selection region 210 using a web browser. Languages which can be supported the voice recognizing device 113 are displayed in the language selection region 210, and if the language is selected, a notification is given to the call recording information managing device 109. When the voice recognition is performed in real time, a predetermined voice recognition engine is selected on the basis of the CTI information (for example, the incoming call number) when it starts (when the incoming call is received).

When the operator 108 switches the language of the voice recognition engine, the operator 108 selects the language in the language selection region 210. The voice recognition engine corresponding to the selected language is decided using a table, and the voice recognition engine is immediately switched.

The language selection region is an operator PC screen in which Japanese and English are selectable. The operator 108 manipulates the operator terminal 104 and selects the language in the language selection region 210. In this case, the operator 108 can select Japanese or English in the language selection region 210. The language is decided if a “submit” button 220 in the language selection region 210 is pushed after the language is selected. A voice recognition result 230 accumulated in the voice recognition result managing device 112 is displayed in the call content display region 200.

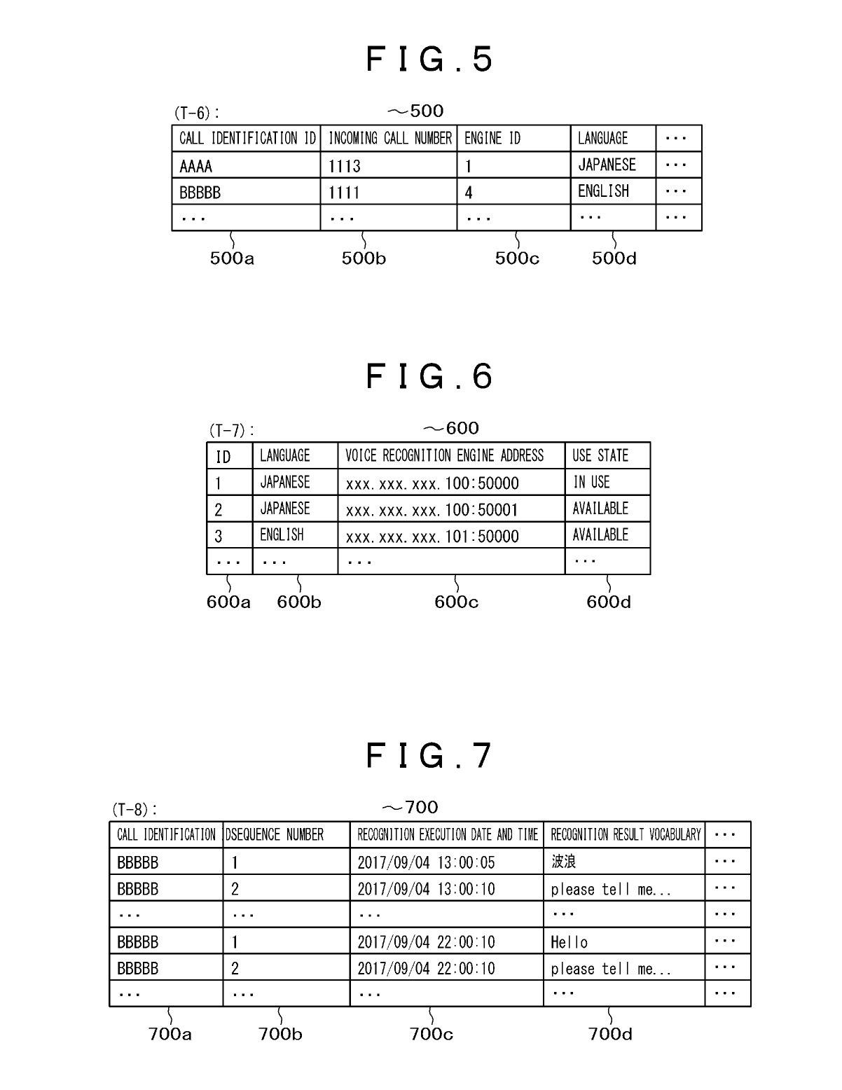

The call recording information managing device 109 includes an incoming call number language correspondence table 300 (a table (T-4) of FIG. 3), a manual switching table 400 (a table (T-5) in FIG. 4), a call information table 500 (a table (T-6) of FIG. 5), and a voice recognition result table 700 (a table (T-8) of FIG. 7). The voice recognition control device 111 includes a voice recognition engine selection table 600 (a table (T-7) of FIG. 6).

As illustrating in FIG. 3, the incoming call number language correspondence table (T-4) 300 is a table in which an incoming call number 300a is associated with a language 300b. For example, “Japanese” of the language 300b corresponds to “111” of the incoming call number 300a.

As illustrating in FIG. 4, the manual switching table (T-5) 400 is a table in which a switching ID 400a is associated with a language 400b. It is a table which enables the operator 108 to switch and select Japanese or English manually when selecting the language. For example, “Japanese” of the language 400b corresponds to “F001” of the switching ID 400a, and “English” of the language 400b corresponds to “F002” of the switching ID 400a.

As illustrating in FIG. 5, the call information table (T-6) 500 is a table for managing a call identification ID 500a, an incoming call number 500b, an engine ID 500c, and a language 500d in association with one another. For example, “Japanese” of the language 500d corresponds to “AAAA” of the call identification ID 500a, “1113” of the incoming call number 500b, and “1” of the engine ID 500c. “English” of language 500d corresponds to “BBBB of the call identification ID 500a”, “1111” of the incoming call number 500b, and “4” of the engine ID 500c.

As illustrating in FIG. 6, the voice recognition engine selection table (T-7) 600 is a table for selecting the voice recognition engine. In the voice recognition engine selection table (T-7) 600, an ID 600a, a language 600b, a voice recognition engine address 600c, and a use state 600d are managed in association with one another while considering a correspondence in a case in which there are a plurality of engines for the same language as well. Here, although omitted in the voice recognition engine selection table (T-7) 600, engines of languages of different dialects may be prepared. As languages of different dialects, in the case of English, there are UK English, US English, and the like. For example, in “1” of ID 600a, “Japanese” of the language 600b, and “xxx.xxx.xxx.100.50000” of the voice recognition engine address 600c, the use state 600d indicates “in use.”

As illustrated in FIG. 7, the voice recognition result table (T-8) 700 includes a call identification ID 70a identifying a call, a sequence number 700b assigned in an output order of the voice recognition result, a recognition execution date and time 700c (equivalent to a table addition date and time), and a recognition result vocabulary 700d (one record has data corresponding to one voice interval). Upon receiving the voice recognition result from the voice recognizing device 113, the voice recognition result managing device 112 stores the voice recognition result in the voice recognition result table (T-8) 700. It is determined whether it is real-time recognition during a call or recognition after a call ends on the basis of the recognition execution date and time of the voice recognition result table (T-8). For example, “ [symbol] ” (“Japanese”) of the recognition result vocabulary 700d correspond to “1” of the sequence number 700b of “BBBBB” of the call identification ID 700a and “2017/09/04 13:00:05” of the recognition execution date and time 700c.

Next, an operation of the call voice processing system of the embodiment will be described.

A case in which Japanese engine 113a is selected by automatic selection, and then switching to English engine 113b is performed in the call voice processing system in which Japanese and English are supported will be described as an example.

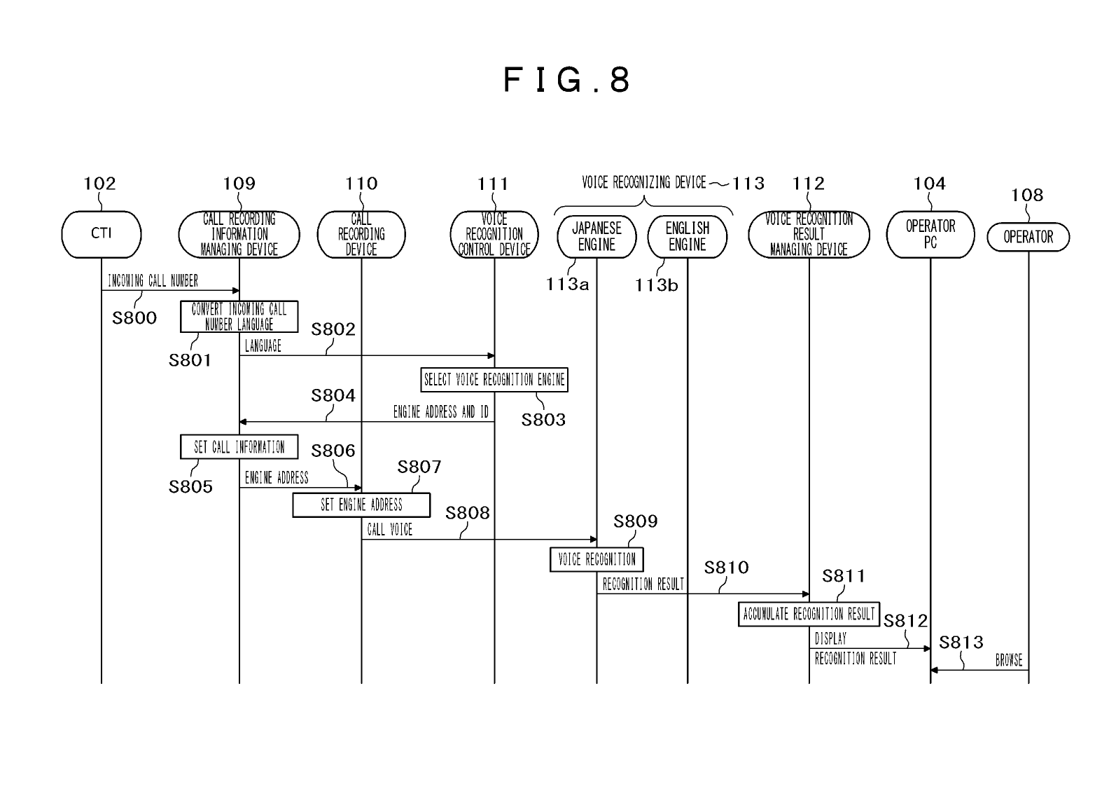

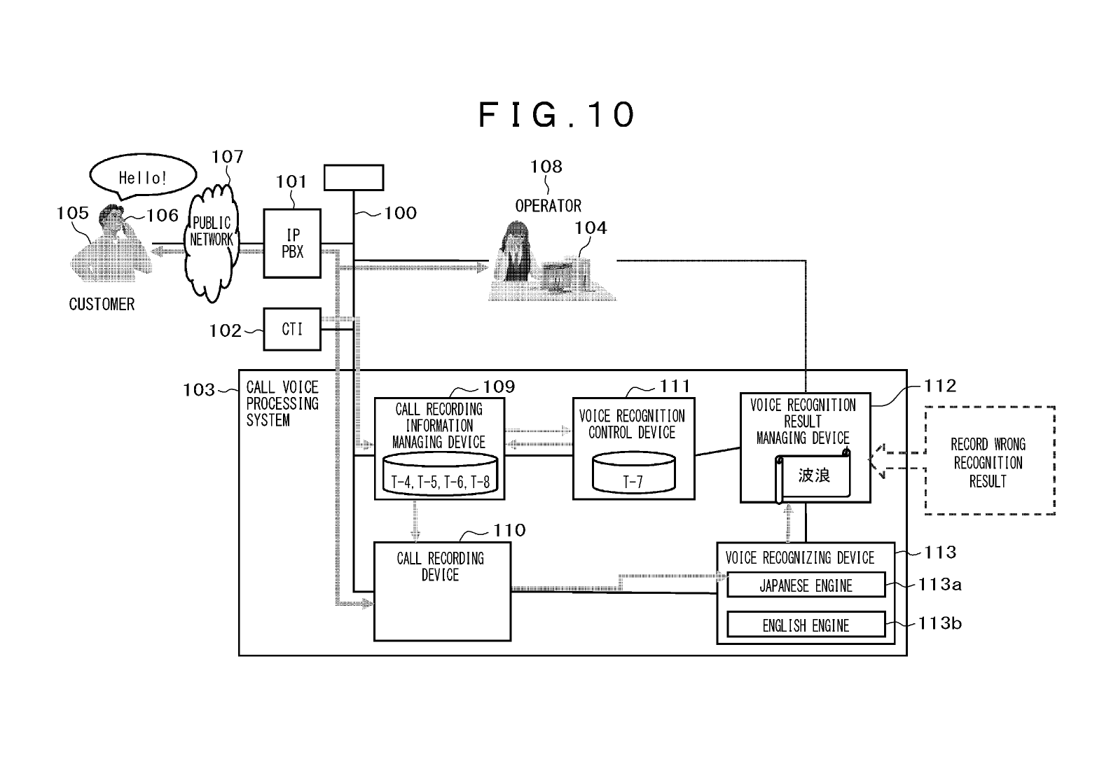

An operation when an incoming call is received will be described with reference to FIGS. 8 and 10.

First, the call recording information managing device 109 receives an incoming call number as the CTI information (the call information) from the CTI device 102 (S800).

The call recording information managing device 109 selects Japanese as the language with reference to the incoming call number language correspondence table 300 (table (T-4) of FIG. 3) in which the incoming call number is associated with the language, performs an incoming call number language conversion process (S801), and gives a notification indicating that Japanese is used as the language to the voice recognition control device 111 (S802).

The voice recognition control device 111 performs a voice recognition engine selection process of selecting the Japanese engine 113a as the voice recognition engine (S803), rewrites the voice recognition engine selection table 600 (table (T-7) of FIG. 6), and transmits a voice recognition engine address and an ID to the call recording information managing device 109 (S804).

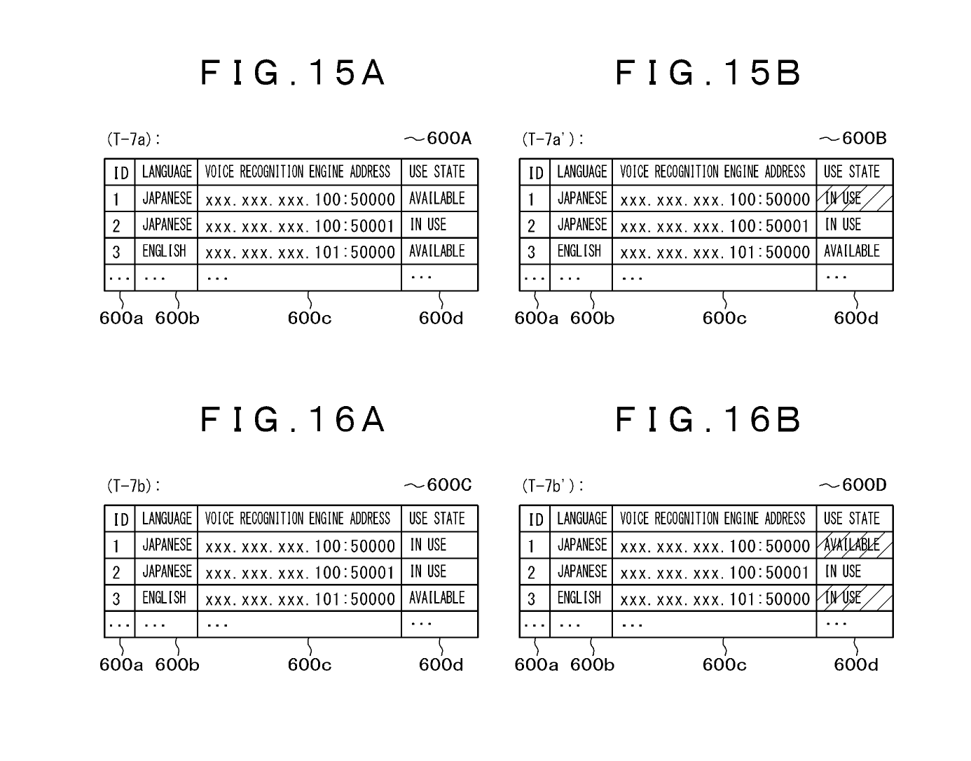

Here, FIG. 15A and FIG. 15B illustrate a voice recognition engine selection table before the rewriting and a voice recognition engine selection table after the rewriting. A table (T-7a) 600A is a table before the rewriting (FIG. 15A), and a table (T-7a′) 600B is a table (FIG. 15B) after the rewriting. Specifically, transition from a state in which “Japanese” of an ID “1” of the voice recognition engine selection table (T-7a) 600A before the rewriting when the incoming call is received is “available” to a state in which “Japanese” of an ID “1” of the voice recognition engine selection table (T-7a′) 600B before the rewriting when the incoming call is received is “in use” is performed.

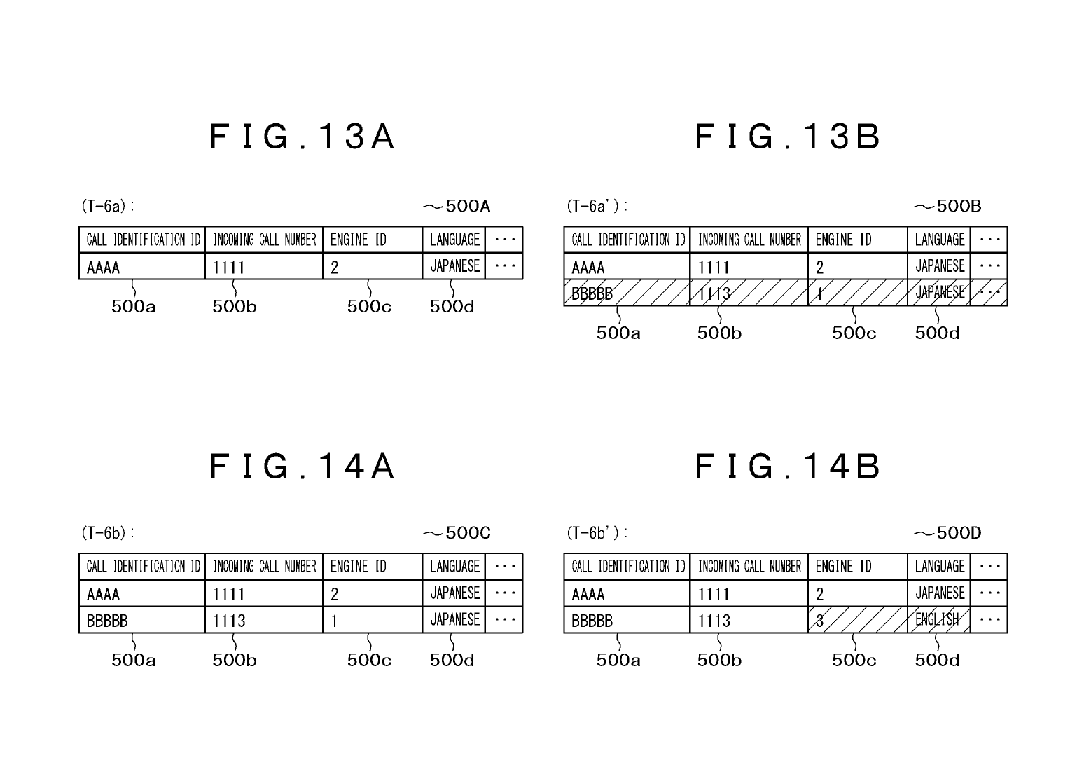

The call recording information managing device 109 sets the call information (S805) and transfers the voice recognition engine address to the call recording device 110 (S806). In this case, the address of Japanese engine 113a is transferred to the call recording device 110. The call recording information managing device 109 adds the call information to the call information table (T-6a) 500 of FIG. 5. Specifically, as illustrating in FIG. 13A and FIG. 13B, the call identification ID “BBBBB”, the incoming call number “1113”, the engine ID “1,” and the language “Japanese” are added to the call information table (T-6a′) 500A before the rewriting when the incoming call is received, and the call information table (T-6a′) 500B after the rewriting when the incoming call is received is generated.

The call recording device 110 records a call, sets the engine address (Japanese engine address), and transfers a mirrored call voice to the voice recognizing device 113 (S808).

The voice recognizing device 113 executes the voice recognition through the Japanese engine 113a (S809) and transfers the recognition result to the voice recognition result managing device (S810).

The voice recognition result managing device 112 accumulates the recognition results transferred from the voice recognizing device 113 (S811).

The recognition results accumulated in the voice recognition result managing device 112 are transferred to the operator terminal 104 (the operator PC), and the voice recognition results are displayed in the call content display region 200 (see FIG. 2) of the operator PC screen (S812).

The operator 108 browses the recognition results displayed in the call content display region 200 of the operator PC screen (S813).

In this case, as illustrating of FIG. 10, in a case in which the customer 105 speaks in English instead of Japanese during the call, the voice recognizing device 113 executes the voice recognition through the Japanese engine 113a and transfers the recognition result to the voice recognition result managing device 112. In this case, the voice recognition result managing device 112 accumulates and records a wrong recognition result transferred from the voice recognizing device 113. Then, the wrong recognition result accumulated in the voice recognition result managing device 112 is transferred to the operator terminal (the operator PC) 104, and the wrong voice recognition result is displayed in the call content display region 200 of the operator PC screen.

The operator 108 browses the wrong recognition result displayed in the call content display region 200 of the operator PC screen.

For example, in a case in which the customer 105 speaks “Hello,” the voice recognizing device 113 executes the voice recognition through the Japanese engine 113a and recognizes it as “ [symbol] ” (“Japanese”). As a result, the wrong recognition result (“ [symbol] ” (“Japanese”)) is accumulated in the voice recognition result managing device 112. The wrong recognition result accumulated in the voice recognition result managing device 112 (“ [symbol] ” (“Japanese”)) is displayed in the call content display region 200 of the operator PC screen.

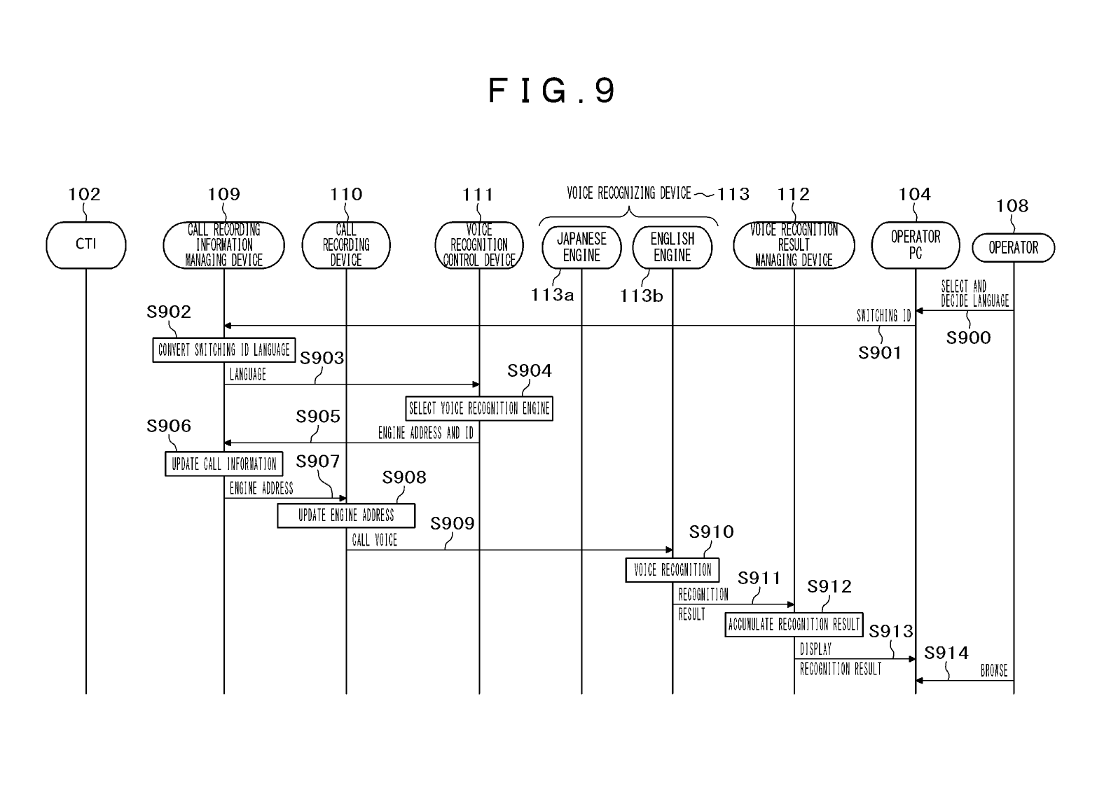

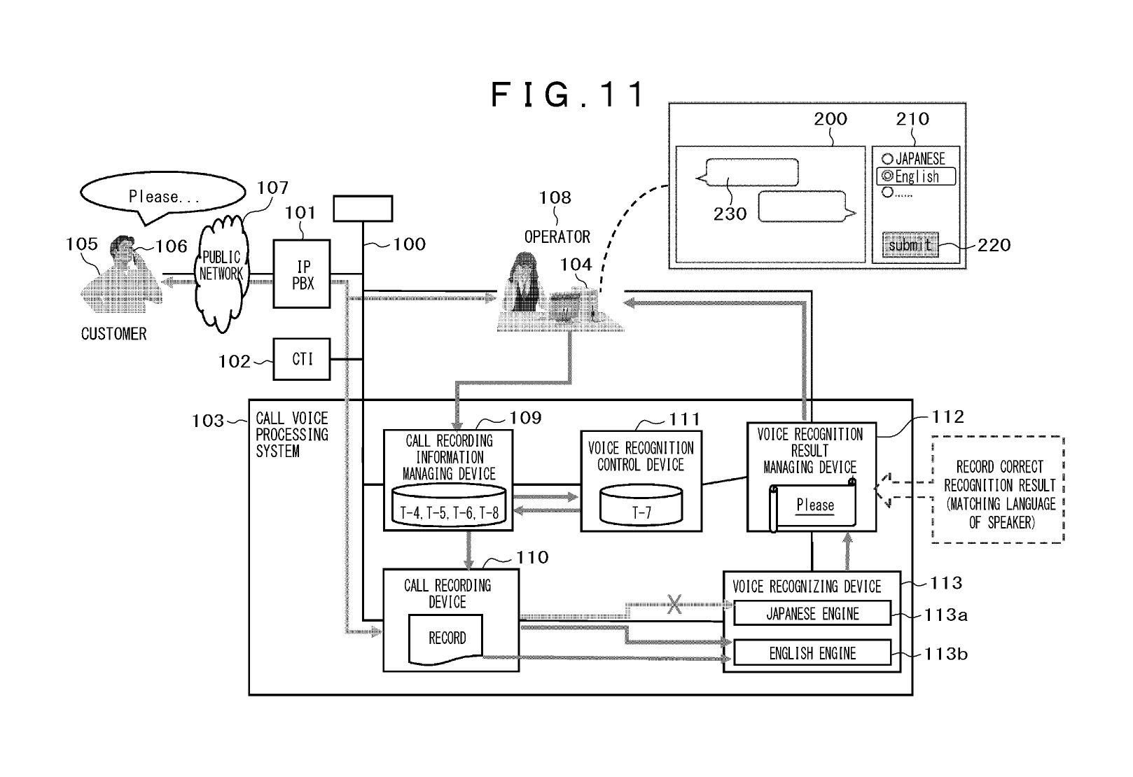

Next, an operation when the voice recognition engine is switched by the operator manipulation will be described with reference to FIGS. 9 and 11.

The operator 108 browses and checks the wrong recognition result (“ [symbol] ” (“Japanese”) of FIG. 10)) displayed in the call content display region 200 of the operator PC screen, notices the error of the voice recognition engine, and switches the language of the voice recognition from Japanese to English. In order to switch the language of the voice recognition to English, the operator 108 select English in the language selection region 210 displayed on operator PC screen, pushes the “submit” button 220, and selects and decides English as the language (S900). Then, a notification of the switching ID (F002) for English is given to the call recording information managing device 109 (S901).

The call recording information managing device 109 converts the language to English which is a language corresponding to English switching ID (F002) with reference to the manual switching table 400 (the table (T-5) of FIG. 4) (S902).

The call recording information managing device 109 gives a notification of English which is the language converted using the manual switching table 400 (the table (T-5) of FIG. 4) to the voice recognition control device 111 and gives a notification indicating that the English engine is used as the voice recognition engine to the voice recognition control device 111 (S903).

The voice recognition control device 111 selects the English engine 113b as the voice recognition engine (S904) and transmits the English engine address and the ID which can be used for rewriting of the voice recognition engine selection table 600 (the table (T-7) of FIG. 6) (S905). Here, the tables before and after the rewriting at the time of switching are illustrating in a table (T-7b) 600C and a table T-7b′(600D) illustrating in FIG. 16A and FIG. 16B.

Specifically, transition from a state in which “Japanese” of ID “1” of the voice recognition engine selection table (T-7b) 600C before the rewriting at the time of manual switching is “in use” to a state in which “Japanese” of ID “1” of the voice recognition engine selection table (T-7b′) 600D after the rewriting at the time of manual switching is “available” is performed. In addition, transition from a state in which “English” of the ID “3” of the voice recognition engine selection table (T-7b) 600C before the rewriting at the time of manual switching is “available” to a state in which “English” of the ID “3” of the voice recognition engine selection table (T-7b′) 600D before the rewriting at the time of manual switching is “in use” is performed.

The call recording information managing device 109 updates the call information (S906). Specifically, the ID of the English engine 113b that uses the ID of the voice recognition engine associated with the call information is updated. Then, the call recording information managing device 109 transfers the English engine address to the call recording device 110 (S907).

As illustrating in FIG. 14A and FIG. 14B, the call recording information managing device 109 switches the call information table (T-6b) 500C before the rewriting at the time of manual switching to the call information table (T-6b′) 500D after the rewriting at the time of manual switching. Specifically, the engine ID of the call identification ID “BBBBB” of the call information table (T-6b) 500C before the rewriting at the time of manual switching is switched from “1” to “3,” the language is switched from “Japanese” to “English,” and the call information table (T-6b′) 500 D after the rewriting at the time of manual switching is generated.

The call recording device 110 updates the address of the voice recognition engine (S908) and transfers the call voice to the voice recognizing device (S909).

The voice recognizing device 113 executes the voice recognition using the switched English engine 113b (S910), and transmits the recognition result to the voice recognition result managing device 112 (S911).

The voice recognition result managing device 112 accumulates the recognition result transferred from the voice recognizing device 113 (S912).

The recognition result accumulated in the voice recognition result managing device 112 is transferred to the operator terminal (operator PC) 104 and the voice recognition result is displayed in the call content display region 200 of the operator PC screen (see FIG. 2) (S913).

The operator 108 browses the recognition result displayed in the call content display region 200 of the operator PC screen (S914).

In this case, as illustrating of FIG. 11, in a case in which the customer 105 speaks in English during the call, the voice recognizing device 113 executes the voice recognition through the English engine 113b and transfers the recognition result to the voice recognition result managing device 112. In this case, the voice recognition result managing device 112 accumulates the correct recognition result (according to the customer's language) transferred from the voice recognizing device 113. Then, the correct recognition result accumulated in the voice recognition result managing device 112 is transferred to the operator terminal (operator PC) 104, and the correct voice recognition result is displayed in the call content display region 200 of the operator PC screen. The operator 108 browses the correct recognition result displayed in the call content display region 200 of the operator PC screen.

For example, in a case in which the customer 105 speaks “Please,” the voice recognizing device 113 executes the voice recognition through the English engine 113b, recognizes “Please,” and accumulates the correct recognition result (“Please”) in the voice recognition result managing device 112. The correct recognition result (“Please”) accumulated in the voice recognition result managing device 112 is displayed in the call content display region 200 of the operator PC screen.

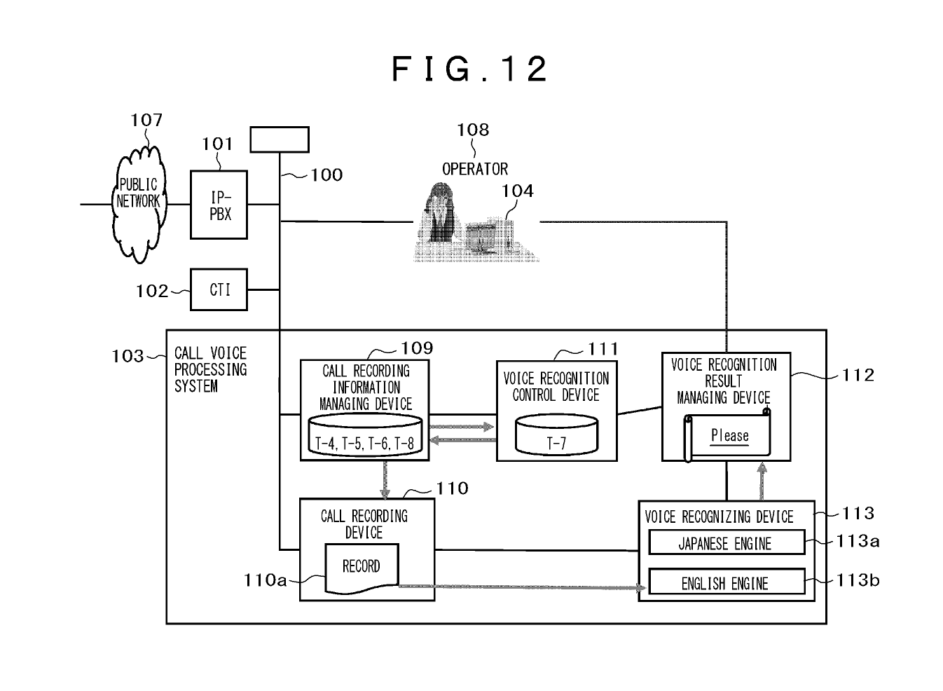

Finally, a re-execution operation when the recognition engine fails to be switched will be described with reference to FIG. 12. After the call ends, the call recording device 110 outputs a call record as a recording file 110a and transfers the recording file 110a to the voice recognizing device 113. The voice recognizing device 113 executes the voice recognition on the recording file 110a and accumulates the recognition result in the voice recognition result managing device 112.

Specifically, in a case in which the English engine 113b is unable to be immediately switched to the English engine 113b during the call, the recording file 110a which is output after the end of the call at which the English engine 113b becomes available is transferred to the voice recognizing device 113. After call ends, the voice recognition is executed using the English engine 113b.

Specifically, after an incoming call is received, it is determined whether or not the English engine 113b is in use. In a case in which it is determined that the English engine 113b is not in use, and the English engine 113b is available, the voice information during the call after the incoming call is received is recognized using the English engine 113b.

On the other hand, in a case in which it is determined that the English engine 113b is in use, and the English engine 113b is unavailable, the voice information after the incoming call is received is recognized using the English engine 113b after the call ends.

According to the embodiment, in an embodiment, a function of enabling the operator to select the voice recognition engine through a manual manipulation is provided in addition to the automatic selection of the voice recognition engine based on the CTI information. Accordingly, it is possible to select the appropriate voice recognition engine while suppressing the use of the system resources.

1. A call voice processing system, comprising:
a voice recognizing device including a plurality of voice recognition engines for performing voice recognition of a plurality of languages;
a call recording information managing device including a language correspondence table in which a plurality of pieces of call information are associated with a plurality of languages and a switching table for performing switching to one of the plurality of languages; and
a voice recognition control device including a voice recognition engine selection table in which the plurality of languages are associated with the plurality of voice recognition engines,
wherein, when an incoming call is received, the voice recognition control device automatically decides a first language as a language corresponding to the call information with reference to the language correspondence table,
the voice recognizing device recognizes the voice information during the call when the incoming call is received using a first voice recognition engine corresponding to the first language with reference to the voice recognition engine selection table,
after the incoming call is received, the voice recognition control device switches the first language to a second language different from the first language with reference to the switching table in response to a switching instruction to instruct switching from the first language to the second language, and
the voice recognizing device recognizes the voice information during the call after the incoming call is received using a second voice recognition engine corresponding to the second language with reference to the voice recognition engine selection table.

2. The call voice processing system according to claim 1, further comprising:
a call recording device that records the voice information during the call in a recording file,
wherein, when the incoming call is received, the call recording device records the voice information during the call when the incoming call is received in the recording file,
the voice recognizing device recognizes the voice information during the call when the incoming call is received recorded in the recording file using the first voice recognition engine, and
after the incoming call is received, the call recording device records the voice information during the call after the incoming call is received in the recording file, and
the voice recognizing device recognizes the voice information during the call after the incoming call is received recorded in the recording file using the second voice recognition engine.

3. The call voice processing system according to claim 1, wherein, after the incoming call is received, the voice recognition control device switches the first language to the second language in response to the switching instruction given through a language selection screen displayed on a manipulating terminal manipulated by an operator.

4. The call voice processing system according to claim 3, further comprising:
a voice recognition result managing device that causes a voice recognition result obtained by recognizing the voice information using the voice recognition engine of the voice recognizing device to be displayed in a call content display region of the manipulating terminal, and causes the language selection screen to be displayed in a language selection region adjacent to the call content display region.

5. The call voice processing system according to claim 4, wherein the voice recognition result managing device accumulates the voice recognition result obtained by recognizing the voice information when the incoming call is received using the first voice recognition engine, displays the accumulated voice recognition result in the call content display region, and gives a notification of an instruction to switch from the first language to the second language to the call recording information managing device in accordance with the voice recognition result.

6. The call voice processing system according to claim 5, wherein, when the notification of the instruction to switch from the first language to the second language is received, the call recording information managing device gives a notification indicating that the voice information after the incoming call is received is recognized using the second voice recognition engine to the voice recognizing device, accumulates the voice recognition result obtained by recognizing the voice information during the call after the incoming call is received using the second voice recognition engine in response to the notification, and displays the accumulated voice recognition result in the call content display region.

7. The call voice processing system according to claim 1, wherein the language correspondence table of the call recording information managing device is an incoming call number language correspondence table in which incoming call numbers serving as the call information are associated with the plurality of languages.

8. A call voice processing method, comprising:
preparing a first voice recognition engine for performing voice recognition of a first language and a second voice recognition engine for performing voice recognition of a second language different from the first language;
automatically deciding the first language as a language corresponding to call information when an incoming call is received;
recognizing voice information during a call when the incoming call is received using the first voice recognition engine corresponding to the first language;
determining whether or not the second voice recognition engine corresponding to the second language is in use in response to a switching instruction to instruct switching from the first language to the second language after the incoming call is received;
switching the first language to the second language in a case in which it is determined that the second voice recognition engine is not in use and the second voice recognition engine is available and recognizing the voice information during the call after the incoming call is received using the second voice recognition engine corresponding to the second language; and
recognizing the voice information after the incoming call is received after the call ends using the second voice recognition engine corresponding to the second language in a case in which it is determined that the second voice recognition engine is in use, and the second voice recognition engine is unavailable.

9. The call voice processing method according to claim 8, wherein the voice information during the call is recorded in a recording file,
the voice information recorded in the recording file is recognized using the second voice recognition engine after the call ends.

10. The call voice processing method according to claim 8, wherein, after the incoming call is received, the first language is switched to the second language in response to the switching instruction given through a language selection screen displayed on a manipulating terminal manipulated by an operator.

11. The call voice processing method according to claim 8, wherein a voice recognition result obtained by recognizing the voice information when the incoming call is received using the first voice recognition engine is displayed,
an instruction to switch from the first language to the second language is given in accordance with the voice recognition result after the incoming call is received,
the voice information after the incoming is received is recognized using the second voice recognition engine on the basis of the instruction, and
the voice recognition result obtained by recognizing the voice information after the incoming call is received using the second voice recognition engine is displayed.
